(19) United States
(12) Patent Application Publication
(10) Pub. No.: US 2025/0058453 A1
(43) Pub. Date: Feb. 20, 2025

(54) SKWEEG-IT

(71) Applicant: Jeff Gearhart, Monument, CO (US)

(72) Inventor: Jeff Gearhart, Monument, CO (US)

(21) Appl. No.: 18/933,224

(22) Filed: Oct. 31, 2024

Related U.S. Application Data
(63) Continuation-in-part of application No. 18/383,424, filed on Oct. 24, 2023.
(60) Provisional application No. 63/423,356, filed on Nov. 7, 2022.

(51) Int. Cl. B25G 3/38; A47L 13/11

(52) U.S. Cl. CPC B25G 3/38; A47L 13/11

(57) ABSTRACT

A system includes a first portion of a blade configured at an initial position. The first portion of the blade is configured to move or bend in one or more directions. The system also includes a second portion of the blade positioned underneath the first portion of the blade. The second portion of the blade consists of one or more different materials than the first portion of the blade. The second portion of the blade is configured to move and bend in conjunction with the first portion of the blade in the one or more directions. The system also includes a handle connected to the first and second portion of the blade. The handle is configured to move and bend the first and second portion of the blade on one or more surfaces.

### CROSS-REFERENCE TO RELATED APPLICATION

This application is a continuation-in-part application that claims priority to U.S. Non-Provisional application Ser. No. 18/383,424, entitled “SKWEEG-IT” filed Oct. 24, 2023, and Provisional Application Ser. No. 63/423,356, filed Nov. 7, 2022, entitled “SKWEEG-IT,” the disclosure of which is hereby expressly incorporated herein by reference in its entirety.

### TECHNICAL FIELD

The present disclosure generally relates to a flexible device used to remove dirt, snow, and other materials on a variety of surfaces.

### BACKGROUND

Current cleaning systems will attempt to clean snow, water, and dirt from surfaces. The surfaces will have many irregularities within the debris including the snow, water, and dirt. The irregularities in the surface can hamper the effectiveness of the cleaning system. The cleaning system will often not be able to clean through the irregularities. Damage can also occur to the cleaning systems when trying to perform cleaning intervals through the irregularities.

Such cleaning systems can include the common shovel that users will use to lift and move dirt and snow. However, the shovel is a rigid and fixed device. The shovel will often not be able to lift and remove snow and dirt to the irregularies. The shovel will remain rigid in its composition, and not be able to be repositioned relative to the handle to obtain the leverage needed to remove the snow and dirt with irregularities.

The main problem with current cleaning systems the rigidity of the cleaning system to not be able to adapt to the irregularities in the snow, dirt, and water that will occur on various surfaces. The cleaning system will often be unable to clean such debris with irregularities or unevenness in the surface.

As such, a need exits for a cleaning system with the flexibility to adapt to the irregularities that occur on various surfaces. Moreover a need exists for a cleaning system to be able to be adjusted from its original position to clean the debris with on the surface with various irregularities.

### SUMMARY

The following summary is provided to facilitate an understanding of some of the features of the disclosed embodiments and is not intended to be a limiting description. A full appreciation of the various aspects of the embodiments disclosed herein can be gained by taking the specification, claims, drawings, and abstract as a whole. The aforementioned aspects and other objectives are now achieved as described herein.

In an embodiment, a system includes a first portion of a blade configured at an initial position. The first portion of the blade is configured to move or bend in one or more directions. The system also includes a second portion of the blade positioned underneath the first portion of the blade. The second portion of the blade consists of one or more different materials than the first portion of the blade. The second portion of the blade is configured to move and bend in conjunction with the first portion of the blade in the one or more directions. The system also includes a handle connected to the first and second portion of the blade. The handle is configured to move and bend the first and second portion of the blade on one or more surfaces.

The first portion of the blade also includes polycarbonate material.

In an embodiment, a system includes a handle positioned at an initial position to remove one or more items from at least one surface. The system also includes a lower blade positioned in contact with the handle. The lower blade is made of flexible material. The lower blade is configured to bend in one or more directions to remove the one or more items from the at least one surface. The system also incudes an upper blade positioned over the lower blade. The upper blade is configured to twist and bend in the one or more directions to assist the lower blade and the handle to remove the one or more items from the at least one surface.

The handle is configured to be positioned in a perpendicular direction to the lower blade and the upper blade.

In an embodiment, a method includes configuring a first portion of a blade at an initial position, wherein the first portion of the blade is configured to move or bend in one or more directions. The method also includes positioning a second portion of the blade underneath the first portion of the blade. The second portion of the blade consists of one or more different materials than the first portion of the blade. The second portion of the blade is configured to move and bend in conjunction with the first portion of the blade in the one or more directions. The method also includes connecting a handle to the first and second portion of the blade. The handle is configured to move and bend the first and second portion of the blade one one or more surfaces.

The method also includes configuring the second portion of the blade with more bendable materials than the first portion of the blade.

### BRIEF DESCRIPTION OF THE FIGURES

The accompanying figures, in which like reference numerals refer to identical or functionally similar elements throughout the separate views and which are incorporated in and form a part of the specification, further illustrate the present disclosure and, together with the detailed description, serve to explain the principles of the present disclosure.

FIG. 1 illustrates a view of a system in accordance with an embodiment of the present disclosure;

FIG. 2 illustrates another view of the system in accordance with an embodiment of the present disclosure;

FIG. 3 illustrates yet another view of the system in accordance with an embodiment of the present disclosure;

FIG. 4 illustrates a further view of the system in accordance with an embodiment of the present disclosure;

FIG. 5 illustrates another view of the system in accordance with an embodiment of the present disclosure;

FIG. 6 also illustrates a further embodiment of the invention;

FIG. 7(A) illustrates another embodiment of the invention;

FIG. 7(B) also illustrates another embodiment of the invention; and

FIG. 8 illustrates a flowchart in accordance with an embodiment of the invention.

Unless otherwise indicated illustrations in the figures are not necessarily drawn to scale.

### DETAILED DESCRIPTION

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein, example embodiments are provided merely to be illustrative. Likewise, a reasonably broad scope for claimed or covered subject matter is intended. Among other issues, subject matter may be embodied as methods, devices, components, or systems. The followed detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as a “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

One having ordinary skill in the relevant art will readily recognize the subject matter disclosed herein can be practiced without one or more of the specific details or with other methods. In other instances, well-known structures or operations are not shown in detail to avoid obscuring certain aspects. This disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Unless defined otherwise, all technical and scientific terms used herein have the same meanings as commonly understood by one of ordinary skill in the art to which the disclosed embodiments belong. Preferred methods, techniques, devices, and materials are described, although any methods, techniques, devices, or materials similar or equivalent to those described herein may be used in the practice or testing of systems and methods of the present disclosure.

Although claims have been included in this application to specific enumerated combinations of features, it should be understood the scope of the present disclosure also includes any novel feature or any novel combination of features disclosed herein.

References “an embodiment,” “example embodiment,” “various embodiments,” “some embodiments,” etc., may indicate that the embodiment(s) so described may include a particular feature, structure, or characteristic, but not every possible embodiment necessarily includes that particular feature, structure, or characteristic.

Headings provided are for convenience and are not to be taken as limiting the present disclosure in any way.

Each term utilized herein is to be given its broadest interpretation given the context in which that term is utilized.

The following paragraphs provide context for terms found in the present disclosure (including the claims):

The transitional term “comprising”, which is synonymous with “including,” “containing,” or “characterized by,” is inclusive or open-ended and does not exclude additional, unrecited elements or method steps. See, e.g., Mars Inc. v. H.J. Heinz Co., 377 F.3d 1369, 1376, 71 USPQ2d 1837, 1843 (Fed. Cir. 2004) (“[L] ike the term ‘comprising,’ the terms ‘containing’ and ‘mixture’ are open-ended.”). “Configured to” or “operable for” is used to connote structure by indicating that the mechanisms/units/components include structure that performs the task or tasks during operation. “Configured to” may include adapting a manufacturing process to fabricate components that are adapted to implement or perform one or more tasks.

“Based On.” As used herein, this term is used to describe factors that affect a determination without otherwise precluding other or additional factors that may affect that determination. More particularly, such a determination may be solely “based on” those factors or based, at least in part, on those factors.

All terms of example language (e.g., including, without limitation, “such as”, “like”, “for example”, “for instance”, “similar to”, etc.) are not exclusive of other examples and therefore mean “by way of example, and not limitation . . . ”.

A description of an embodiment having components in communication with each other does not infer that all enumerated components are needed.

A commercial implementation in accordance with the scope and spirit of the present disclosure may be configured according to the needs of the particular application, whereby any function of the teachings related to any described embodiment of the present disclosure may be suitably changed by those skilled in the art.

The flowcharts and diagrams in the figures illustrate the architecture, functionality, and operation of possible implementations of systems and methods according to various embodiments. Functions noted in the block may occur out of the order noted in the figures. For example, two blocks shown in succession may, in fact, be executed substantially concurrently, or the blocks may sometimes be executed in the reverse order, depending upon the functionality involved.

Further, any sequence of steps that may be described does not necessarily indicate a condition that the steps be performed in that order. Some steps may be performed simultaneously.

Embodiments of the present disclosure a cleaning system that includes a flexible blade that includes an upper portion and a lower portion. The upper portion of the blade consists of, and is not limited to, polycarbonate and plexiglass. The upper portion of the blade is configured to be sturdy but also flexible. The lower portion of the blade is underneath the upper portion of the blade, and is also connected to the upper portion of the blade. The lower portion of the blade includes, but is not limited to, rubber and other flexible materials. The upper portion of the blade is more sturdy than the lower portion of the blade, but the combined portions form the blade, and enable the blade to be flexible when encountering irregularities in a surface. Moreover, the rubber portion of the lower blade will not scratch or damage the surface that is being cleaned.

Embodiments of the present disclosure also include a handle that is connected to the blade by a locking mechanism. The locking mechanism enables the blade and handle to be adjusted in various directions. The components make up the cleaning system. The cleaning system will be flexible and be able to safely and efficiently manuever around any irregularities in a surface due to the flexibility of the blade.

The user will apply the cleaning system in a series of cleaning intervals on places such as the user's driveway, sidewalk, and/or garage. The handle and blade can be in perpendicular to one another. However, the flexibility provided with the blade and locking mechanism will enable the angle of both the handle and the blade to be adjusted to handle the irregularities that occur in the surface.

The user will use the cleaning system to remove and wipe away snow, dirt, debris, and other materials from the various surfaces. The user can adjust the angle of both the handle and the blade to remove and clean the debris from the surfaces. Moreover, the cleaning system retains the flexibility to enable the handle and blade to be in parallel when cleaning the surfaces of the various dirt and debris. The cleaning system is able to clean and remove dirt and debris of the various surfaces with the blade and/or handle being at virtually any angle desired by the user.

The cleaning system will also have a blade that is reversible. The blade will be reversed on the handle. In this embodiment, the user will be able to pull the blade using the handle to clean the one or more surfaces. In addition, the blade can also be easily stored. The blade and handle can be positioned in parallel without taking up excess space in the user's home.

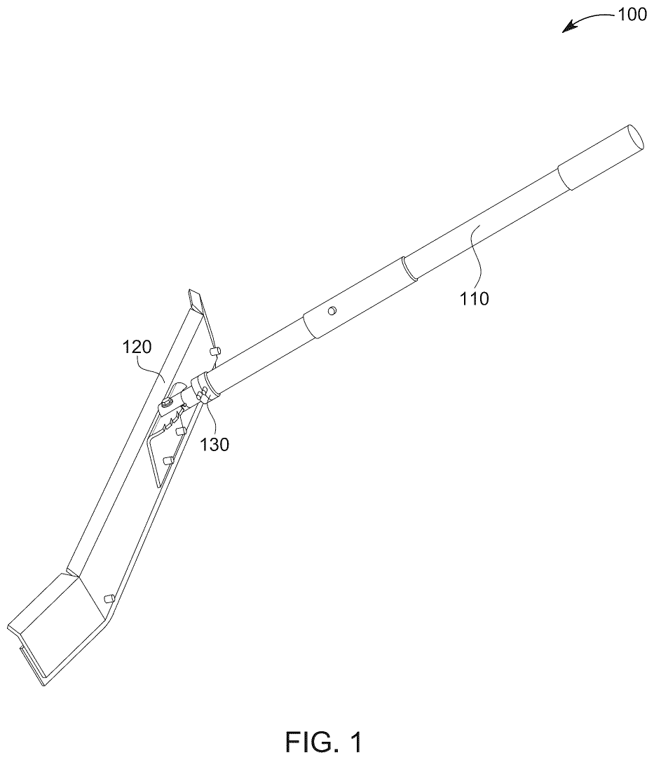

FIG. 1 illustrates a Skweeg-it cleaning system 100, hereinafter known as the “cleaning system” 100. The cleaning system 100 will be used by a user to clean snow and dirt off of the user's outside driveway, sidewalk, and other various surfaces. Moreover, the user can also use the cleaning system 100 inside his/her garage or within the home. Further, other places can also include the sidewalk in front of the user's home. The user can use the cleaning system 100 to move snow, dirt, and other particles to make a walk way more accessible. The cleaning system 100 will also include a handle 110. The handle 110 will be connected to a blade 120. The blade 120 will include a lower portion and an upper portion. The lower portion of the blade 120 will be made of more flexible material such as rubber. The upper portion of the blade 120 will also be made of flexible material, but will be stronger than the lower portion of the blade 120. The upper portion will be configured to prevent from breaking when meeting against snow, dirt, and other debris. The upper portion will be made of polycarbonate and/or plexiglass. A locking mechanism 130 will connect the handle 110 to the blade 120.

Referring to FIG. 1, the cleaning system 100 will have a flexibility at the blade 120 that is not present in other systems. The blade 120 with its upper and lower portion, is built to be sturdy, but also flexible. The user will be able to move the handle 110 to push the blade 120 in any direction to clean a variety of surfaces. The locking mechanism 130 enables the handle 110 to push the blade 120 in a variety of directions, and also maintain control of the blade 120. The locking mechanism 130 will also allow the angle of the blade 120 to be adjusted to various angles while still be securely locked to the handle 110. In other embodiments, the blade 120 will be reversible. In such embodiments, the user will use the handle 110 to pull the blade 120. The blade 120 will move and bend in the variety of directions. The flexibility of the blade 120 due to the flexible materials of the lower portion and upper portion of the blade 120 enable the blade 120 to be able to bend in multiple directions. The handle 110 can be perpendicular to the blade 120 as shown in FIG. 1. In addition, in other embodiments, the flexibility of the blade 120 will enable the handle 110 to be parallel to the blade 120.

Still referring to FIG. 1, the cleaning system 100 will use the flexibility of the blade 120 to clean any debris on the surface when the handle 110 is perpendicular to the blade 120. The user can also readjust the position of the handle 110 to move the blade 120 to various angles when necessary to clean and move the debris away from the surface. The upper portion of the blade 120 will ensure that the blade 120 will remain sturdy and not break when in contact with debris such as garbage, snow, and dirt. The cleaning system 100 will not encounter any rigidity that will prevent the blade 120 from being bent when necessary. The curved edges at both ends of the blade 120 will also provide to the flexibility of the blade 120.

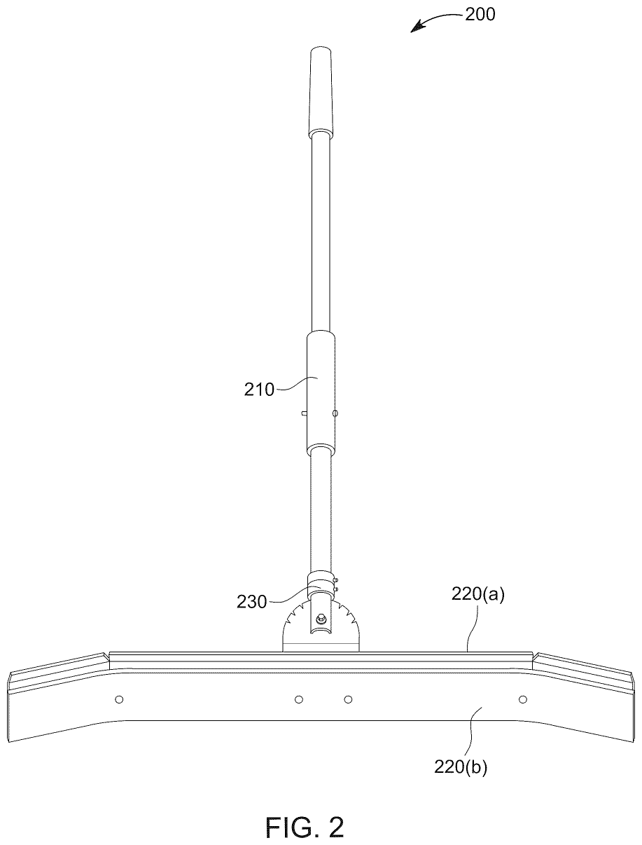

Referring to FIG. 2, another view of the cleaning system 200 is shown. The cleaning system 200 will include the handle 210. The cleaning system 200 will also include the locking mechanism 230 that will connect the handle 210 to the upper blade 220a and the lower blade 220b.

In FIG. 2, the lower blade 220b will be made of rubber-like materials or the like. The lower blade 220b will have a great level of flexibility to move and bend in any number of directions. The user will want to position the cleaning system 200 in any position necessary to remove snow, dirt, and other debris from the surface. The lower blade 220b made of rubber enables the entire cleaning system 200 to remain very flexible in its cleaning position. As such, the lower blade 220b will have the ability to be positioned in a straight or bent, and angled position to remove snow and dirt and other debris. The rubber on the lower blade 220b will ensure that the lower blade 220b will not scratch or damage the surface being cleaned.

Referring again to FIG. 2, the upper blade 220a is also shown. The upper blade 220a is made of stronger materials than the lower blade 220b. Moreover, the upper blade 220a will consist of polycarbonate or plexiglass or the like. The upper blade 220a will also be flexible but remain sturdy when the cleaning system comes into contact with the snow, dirt, and other debris. In other words, the upper blade 220a will not break or suffer any unwanted damage due to its composition. The upper blade 220a will also remain flexible to move and bend in conjunction with the lower blade 220b.

With reference to FIG. 2, the cleaning system 200 can adjust the angle of the combined upper blade 220a and lower blade 220b to provide the force and friction needed to move the debris. The handle 230 will enable the angle of the upper blade 220a and lower blade 220b to be adjusted at any angle while remaining connected to the handle 210. The upper blade 220a and lower blade 220b will provide the strength and flexibility needed to move the materials as the user desires. In addition, the upper blade 220a and lower blade 220b will have the flexibility needed to bend when necessary, or be positioned at a particular angle, to provide the cleaning that is required. The locking mechanism 230 will allow the user to position the handle 210 to manipulate the upper blade 220a and the lower blade 220b into the required positions needed.

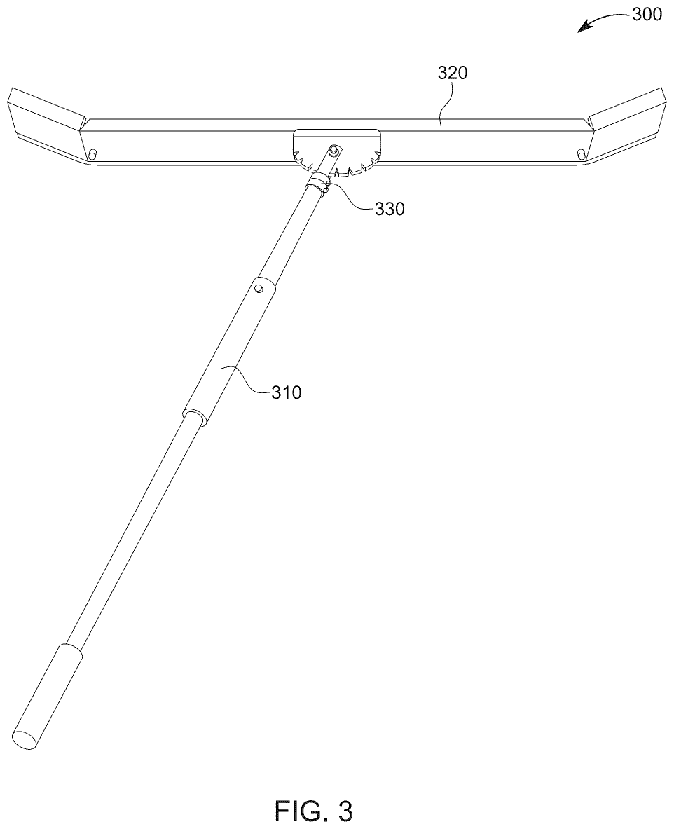

Referring to FIG. 3, another illustration of the cleaning system 300 is illustrated. The cleaning system 300 is shown from the point of the back portion of the handle 310 to the blade 320. A locking mechanism 330 will ensure that the handle 310 is connected to the blade 320 and also enable the handle 310 to manipulate the blade 320 to the necessary direction and angle.

In FIG. 3, the user will grasp the back portion of the handle 310. The user will then move the handle 310 and blade 320 to various points on the surface. The surface can include a garage floor. The user will identify dirt and other debris including snow and water on the surface. The user will also tilt the handle 310 in relation to the blade 320 to obtain the leverage needed to remove the dirt, debris, snow, and/or water from the surface. As shown, the handle 310 is placed at an angle to the blade 320. The user will determine the necessary angle to place the handle 310 and/or the blade 320. When the user encounters the snow, dirt, debris, and/or water, the user will then determine what angle to position the blade 320 and/or handle 310. Irregularities or unevenness in the surface that would make the original set position difficult to remove the snow and dirt will often occur. The user will thereby identify the necessary angle for the blade 320 due to any identified irregularities in the surface. The user can determine that just the handle 310 needs to be adjusted. In other embodiments, can and will determine that the angle of the blade 320 has to be adjusted.

In regard to FIG. 3, the user will continuously adjust the angle of the handle 310 and/or blade 320 in cleaning intervals on the surface. The user will also move the entire cleaning system 300 either forward or backward. Further, the user can also move the cleaning system 300 laterally in either direction. The lack of rigidity of the blade 320 allows the necessary degrees of freedom to move the blade 320, and also the handle 310 in all directions. Moreover, the materials of the blade 320 ensure that the blade is flexible, but also sturdy to not break or be stopped from moving the snow and dirt and debris. The combined rubber, and polycarbonate and plexiglass of the blade 320 ensures that the blade 320 can bend when necessary, but also move and clean up the snow, debris, dirt, and/or water without damaging the surface.

Referring to FIG. 3, the cleaning system 300 is configured to allow the user to move the cleaning system 300 in a multitude of directions in a series of cleaning intervals. The user will be able to continuously adjust the angle of the handle 310 and/or the blade 320. The flexibility and strength of the blade 320 will enable the user to be able to manipulate the blade 320 and, thereby the handle 310 in a plurality of directions to clean the surface of any unwanted materials.

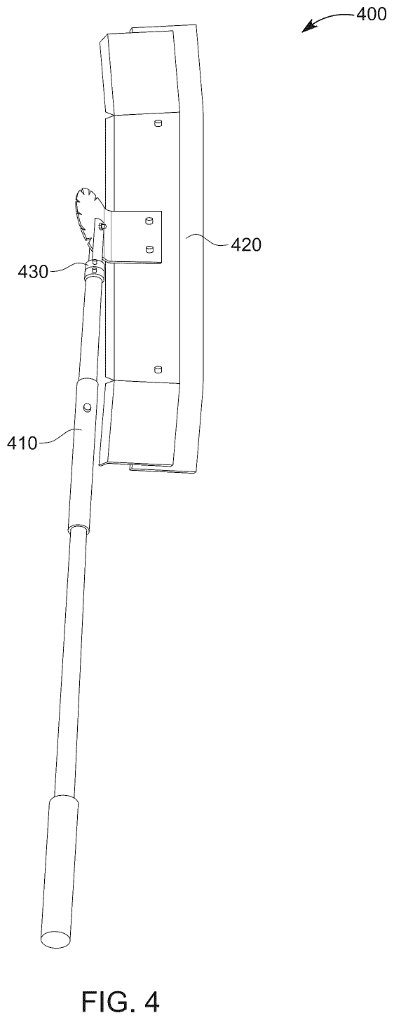

In FIG. 4, another illustration of the cleaning system 400 is shown. The cleaning system 400 will include the handle 410, blade 420, and locking mechanism 430. The cleaning system 400 in many embodiments will have the handle positioned perpendicular to the blade 420. However, the flexibility of the blade 420 and also the handle 410 will allow the handle to also be positioned directly parallel to the blade 420. The locking mechanism 430 will allow the blade to be repositioned at a variety of angles.

Referring again to FIG. 4, the handle 410 will also be positioned in parallel to the blade 420 in multiple embodiments. The user can determine that the best option to remove and clean debris from the surface would be to position the handle 410 in parallel to the blade 420. The locking mechanism 430 will enable the handle 410 to remain in contact and in control of the blade 420 as the blade 420 is adjusted to be in parallel to the handle 410. The user will determine in many situations that keeping the handle 410 at an angle perpendicular to the blade 420 will not produce the necessary leverage to clean and remove the debris from the surface. There could be a patch of dirt and snow that is difficult to remove. The user can decide that the best means to remove the snow and debris is to adjust the angle of the blade 420 to be parallel to the handle 410. The user will thereby manipulate the angle of the handle 410 to be in parallel to the blade 420. In this position, the cleaning system 400 will have the necessary leverage to remove difficult snow and debris from the surface.

In relation to FIG. 4, when the cleaning system 400 encounters difficult materials to remove from the surface, the user will adjust the angle of the handle 410 to be parallel to the blade 420. The user will adjust the handle 410 in relation to the blade 420 to allow the cleaning system 400 to have the necessary leverage to remove the debris, snow, and/or other materials. The flexibility and strength of the blade 420 will enable the materials to be removed without adversely affecting the blade 420.

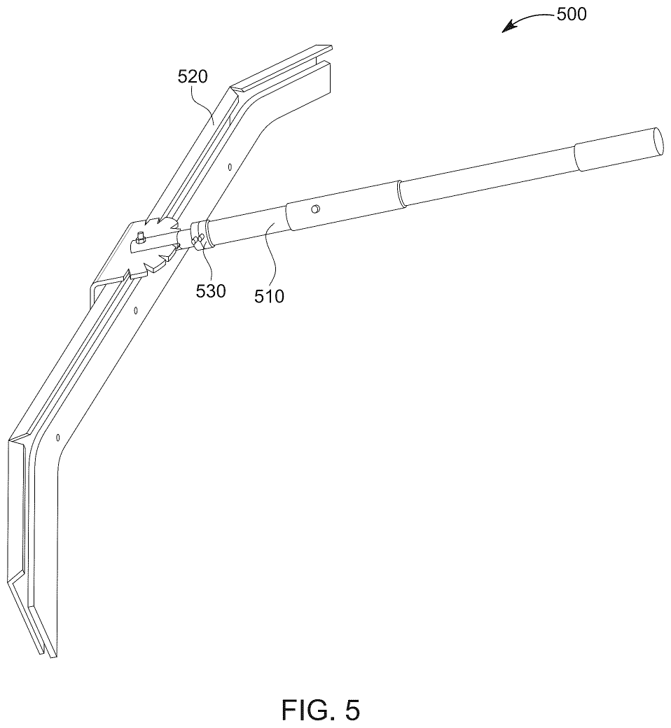

With respect to FIG. 5, another illustration of the cleaning system 500 is shown. As in the other earlier illustrations, the cleaning system 500 will include the handle 510, blade 520, and locking mechanism 530.

In FIG. 5, the user will also want to use the cleaning system 500 to pull debris off of the surface. As such, the user will be able to reverse the blade 520. The user will rotate the blade 520 using the locking mechanism 530. The blade 520 will be rotated one hundred and eighty degrees. The user, in various cleaning intervals, will want to use the handle 510 to pull the blade 520 to clean the surface instead of having to push the blade 520. Reversing the blade 520 will allow the user to pull the blade 520 onto the debris, snow, and/or dirt to remove from the surface or floor. The user can decide at any cleaning interval and at any time to reverse the blade 520 to pull the debris off of the surface. Overall, the user will thereby have the option at any cleaning interval to either use the handle 510 to either push or pull the blade 520 to clean the various surfaces.

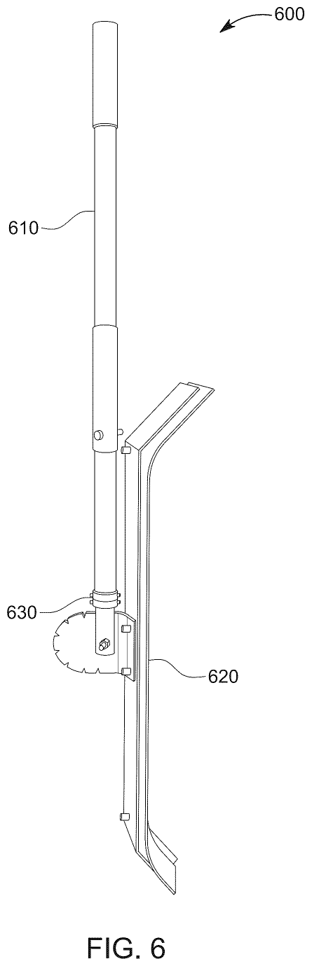

Referring to FIG. 6, the user will determine the number of cleaning intervals that are necessary with the cleaning system 600. Afterward, the user will also know when to store the cleaning system 600. The cleaning system 600 will include the handle 610, blade 620, and locking mechanism 630. The cleaning system 600 can be safely and efficiently stored without taking up too much space in any storage areas in the user's home and/or garage. The user will be able to safely store the cleaning system 600 in a storage area without taking up excess space in and around the storage area.

In FIG. 6, the cleaning system 600 can be hanging on a rack in the user's home and/or garage. As mentioned above, the cleaning system 600 is also not taking up any excess place. The locking mechanism 630 will enable the handle 610 to be positioned in parallel to the blade 620 to not take up too much space in the user's home. The handle 610 can be in parallel to the blade 620 while the handle is safely hanging on the rack so that the cleaning system 600 will not take up excess space. The locking mechanism 630 will ensure that the handle 610 stays connected to the blade 620. Moreover, the blade 620 will be flexible, and lightweight, and not force the handle 610 to fall or be removed from the rack.

With respect to FIG. 6, the cleaning system 600 will be used for a plurality of cleaning intervals. However, before and after the cleaning intervals, the cleaning system 600 will also be safely stored without taking up excess space in the user's home. The handle 610 will be safely manipulated to be in parallel to the blade 620 while hanging on a storage rack within the user's home. The locking mechanism 630 will ensure the handle 610 to remain connected to the blade 620. Further, the flexibility of the blade 620 will enable the handle 610 to be stored in parallel to the blade 620.

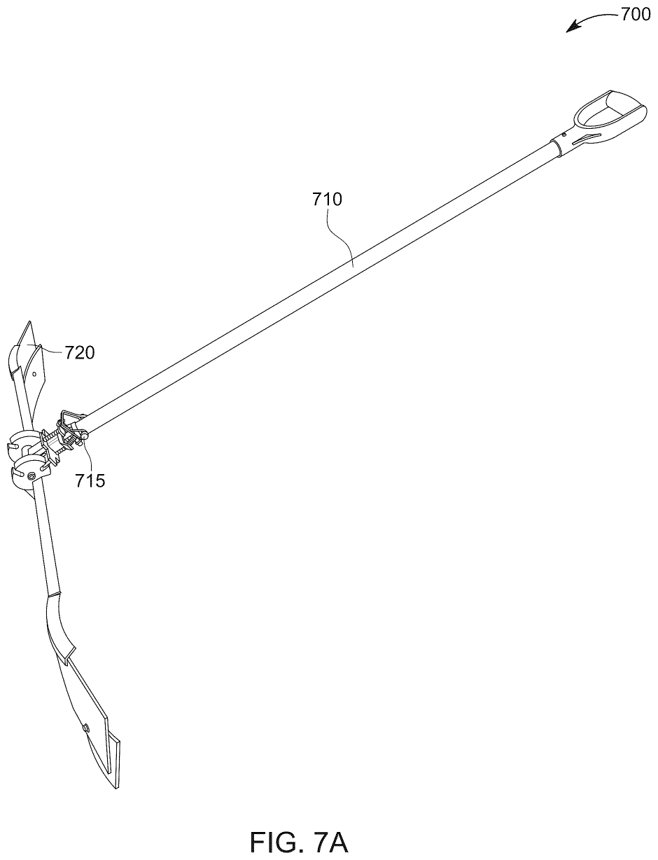

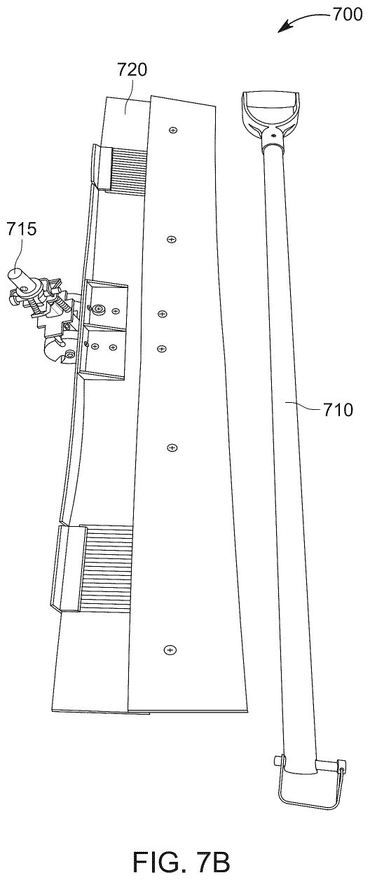

In FIG. 7A, a cleaning system 700 is illustrated with the handle 710 and blade 720. The handle can include rotating gears 715 at an end of the handle 710. As such, the rotating gears 715 can allow the handle 710 to be rotated up to one hundred and eighty degrees. As such, should a user want to shovel the blade 720 in the opposite direction, the user can just use the rotating gears 715 to rotate the handle 710 in the opposite direction. As such, the user is able to rotate the handle 710 when needed when the user has to use the blade 720 in the opposite direction.

In FIG. 7B, another feature of the cleaning system 700 is shown. The rotating gears 715 can allow the handle 710 to be detached from the blade 720. The user can use the rotating gears 715 to detach the handle 710 from the blade 720, and also store the handle 710 with the blade 720. As such, should the user wish to save more space in the storage area for the cleaning system 700, the user can use the rotating gears 715 to detach the handle 710 from the blade 720.

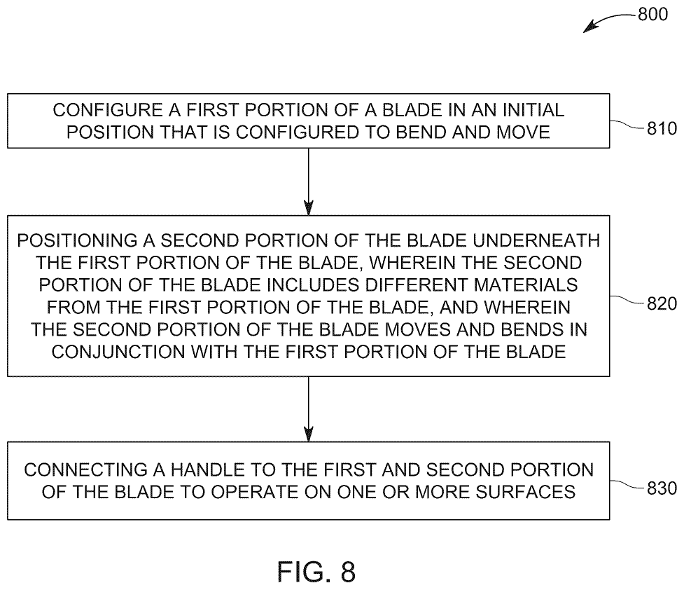

In FIG. 8, a process 800 is illustrated to putting together the cleaning system. A user will want to clean and remove snow, debris, and dirt from a walkway and/or garage within or near the user's home. The user will want to put together the cleaning system to be able to move all types of dirt and debris, and have the cleaning system have a great range of motion needed to clean and remove the dirt and debris.

Referring to FIG. 8, at step 810, the user will configure the blade of the cleaning system in an initial position. The blade will be configured to bend and move in a plurality of directions. The blade will not stay rigid or in one place. The top portion of the blade will be made of polycarbonate, plexiglass, and other materials. The top portion of the blade will be strong enough to clean and remove materials, but also be flexible enough to bend and move at various angles. The blade will also include a lower portion that will be made of rubber and other materials. The lower portion of the blade will be flexible enough to bend and move at various directions and angles and not scratch or damage the surface.

In FIG. 8, at step 820, a second portion, or the lower portion of the blade is positioned underneath a first portion, or the upper portion of the blade. The first portion or top portion of the blade is placed above the lower portion of the blade. The top portion of the blade will be stronger and more sturdy than the bottom portion of the blade. As mentioned above, the top portion of the blade will include polycarbonate, plexiglass, and other materials that will make the top portion more sturdy than the lower portion of the blade. The lower portion of the blade will include rubber and other materials. Both the top portion and bottom portion of the blade will be flexible enough to be bent and moved in various directions to remove snow, dirt, and other debris.

Referring to FIG. 8, at step 830, a handle is connected to the blade. The handle is connected to the blade by a locking mechanism. The locking mechanism ensures that the handle will be able to bend and move the blade in various directions. The handle will remain connected and be able to control the direction and angle of the blade. The entire cleaning system will be used to clean a variety of surfaces and remove unwanted, liquid, and debris from those surfaces.

### Advantages/Summary

The user will often have difficult materials such as a lot of water, dirt, debris to remove from within the user's garage, driveway, and/or sidewalk. The user will want a cleaning system that effectively removes the snow, dirt, and other debris when there are irregularities in the surface. The user will be able to put together a cleaning system that does not have the rigidity of other cleaning systems. The blade of the cleaning system will be flexible enough to be bent at various angles and directions. The blade can be bent and moved at various angles with respect to the handle.

In various embodiments, the user can use the handle while the handle is perpendicular to the blade. The user can determine in many cleaning intervals that aligning the handle in perpendicular to the blade will allow for the greatest leverage to move the debris on the various surfaces. The bottom portion of the blade will remain flexible during the cleaning intervals. The rubber will ensure that the lower portion of the blade will not scratch or damage the surface. In addition, the top portion of the blade will remain sturdy to not break or be stopped from removing the debris during cleaning intervals.

In additional cleaning intervals, the user will determine that the handle has to be in parallel to the blade to clean and remove the dirt and debris. The locking mechanism and flexibility of the entire blade will allow the handle to be positioned in parallel to blade. The user will determine in various cleaning intervals that the best way to remove the snow, debris, and dirt is to place the handle in parallel to the blade. The locking mechanism will ensure that the handle remains connected to the blade during such a cleaning interval.

A further advantage is that the blade is reversible. During cleaning intervals, the user will be able to rotate the blade so that the user can use the handle to pull the debris off of the surface using the blade. As such, the user at any time can decide to either push or pull the debris off of the surface.

Another advantage of the cleaning system is that the cleaning system can be easily stored in any storage area without taking excess space. The flexibility of the blade will allow the handle to be placed in parallel to the blade. The locking mechanism will ensure that the handle stays connected to the blade. The entire cleaning system can be hung on a storage rack and take up only a minimal amount of space in the storage area.

The flexibility of the blade will allow the cleaning system to be able to perform cleaning intervals on various surfaces with both the blade and handle being placed at various positions and angles. The materials of the blade will also ensure that the blade is sturdy enough to have the necessary materials removed from the surface. Finally, the cleaning system can be stored easily in a variety of storage areas with a minimal amount of space required for storage.

Those skilled in the art will appreciate that the example embodiments are non-exhaustive and that embodiments other than that described here may be included without departing from the scope and spirit of the presently disclosed embodiments.

All references, including granted patents and patent application publications, referred herein are incorporated herein by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Various aspects of the present disclosure have been described above by way of illustration, and the specific embodiments disclosed are not intended to limit the present disclosure to the particular forms disclosed. The particular implementation of the system provided thereof may vary depending upon the particular context or application. The present disclosure is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

The corresponding structures, materials, acts, and equivalents of all means or step plus function elements in the claims below are intended to include any structure, material, or act for performing the function in combination with other claimed elements as specifically claimed.

What is claimed is:

1. A system comprising:
a first portion of a blade configured at an initial position, wherein the first portion of the blade is configured to move or bend in one or more directions;
a second portion of the blade positioned underneath the first portion of the blade, wherein the second portion of the blade consists of one or more different materials than the first portion of the blade, and wherein the second portion of the blade is configured to move and bend in conjunction with the first portion of the blade in the one or more directions; and
a handle connected to the first and second portion of the blade, wherein the handle is configured to move and bend the first and second portion of the blade on one or more surfaces.

2. The system of claim 1, wherein the first portion of the blade includes polycarbonate material.

3. The system of claim 1, wherein the handle is rotatable by one-hundred and eighty degrees.

4. The system of claim 1, wherein the handle twists the second portion of the blade in one or more directions.

5. The system of claim 1, wherein the first portion of the blade includes a top edge that is tilted forward.

6. The system of claim 1, wherein the first and second portion of the blade are configured to move one or more items.

7. The system of claim 1, wherein the handle is moved to one or more angles to enable the first and second portion of the blade to remove one or more items.

8. A system comprising:
a handle positioned at an initial position to remove one or more items from at least one surface;
a lower blade positioned in contact with the handle, wherein the lower blade is made of flexible material, wherein the lower blade is configured to bend in one or more directions to remove the one or more items from the at least one surface; and
an upper blade positioned over the lower blade, wherein the upper blade is configured to twist and bend in the one or more directions to assist the lower blade and the handle to remove the one or more items from the at least one surface.

9. The system of claim 8, wherein the handle is configured to be positioned in a perpendicular direction to the lower blade and upper blade.

10. The system of claim 8, wherein the handle is configured in a detached position from the blade.

11. The system of claim 8, wherein the lower blade and upper blade are positioned at a forty-five degree angle to the handle.

12. The system of claim 8, wherein the handle is positioned in a center region within the lower blade and the upper blade.

13. The system of claim 8, wherein the upper blade includes stronger materials than the lower blade.

14. The system of claim 8, wherein the upper blade has a curved edge on at least one end of the upper blade.

15. A method comprising:
configuring a first portion of a blade at an initial position, wherein the first portion of the blade is configured to move or bend in one or more directions;
positioning a second portion of the blade underneath the first portion of the blade, wherein the second portion of the blade consists of one or more different materials than the first portion of the blade, and wherein the second portion of the blade is configured to move and bend in conjunction with the first portion of the blade in the one or more directions; and
connecting a handle to the first and second portion of the blade, wherein the handle is configured to move and bend the first and second portion of the blade on one or more surfaces.

16. The method of claim 15, further comprising:
configuring the second portion of the blade with more bendable materials than the first portion of the blade.

17. The method of claim 15, further comprising:
configuring a curved edge on at least one end of the second portion of the blade.

18. The method of claim 15, further comprising:
configuring a locking mechanism onto the first and second portion of the blade to enable the first and second portion of the blade to be adjusted.

19. The method of claim 15, further comprising:
placing a top edge on the first portion of the blade to enable the first portion of the blade to be tilted forward.

20. The method of claim 15, further comprising:
placing the handle in a parallel direction to the first and second portion of the blade for storage.
